(19) United States
(12) Patent Application Publication
(10) Pub. No.: US 2003/0097282 A1
(43) Pub. Date: May 22, 2003

(54) Intellectual property asset title insurance

(76) Inventors: Shawn D. Guse, Madison, WI (US); Stephen C. Werner JR., Verona, WI (US); Alexander R. Kuszewski, Milwaukee, WI (US)

Correspondence Address: Alexander R. Kuszewski, 318 East Norwich Street, Milwaukee, WI, 53207, US

(21) Appl. No.: 10/301,206

(22) Filed: Nov. 21, 2002

Related U.S. Application Data
(60) Provisional application No. 60/332,211, filed on Nov. 21, 2001.

(51) Int. Cl. G06F 17/60

(52) U.S. Cl. 705/4; 705/1

(57) ABSTRACT

Intellectual property asset title insurance and systems for providing title insurance for intellectual property assets are disclosed. A chain of title is determined for an intellectual property asset. An intellectual property title certificate is issued as verification or confirmation of the chain of title of the intellectual property asset. The invention is useful in transactions involving the buying, selling, transferring, valuation, borrowing against or securing credit with intellectual property assets. The intellectual property title certificate may be in paper or electronic form. A party involved in a transaction takes out an intellectual property title insurance policy prior to receiving the certificate. In some cases, for example, where the absolute chain is not determinable, the title certificate may reflect appropriate riders and exclusions, endorsements, conditions and gap coverage. Letter reports can supplement the actual title certificate and provide additional relevant information to the intellectual property asset. The invention is part of an overall transaction assurances solution, which may be conducted on the internet with a website providing intellectual title insurance services or other intellectual property asset insurance. The policy costs may be determined by valuation of the intellectual property asset, risk of the chain of title history, and how long a chain of history there is to be verified.

### CROSS-REFERENCE TO RELATED APPLICATION

The present application claims the benefit of U.S. Provisional Application No. 60/332,211 filed Nov. 21, 2001, which is incorporated herein by reference.

### BACKGROUND OF THE INVENTION

The present invention is related generally to intellectual property solutions, and more particularly, to intellectual property title insurance for insuring the ownership of an intellectual property asset.

The research, development and protection of intangible assets and other intellectual property are steadily on the rise.

Increasingly, intellectual property is being transferred and licensed between companies, used as collateral for loans, sold on the open market, and used for marketplace valuations of companies. Indeed, for many companies, intellectual property assets represent a significant and in some cases a majority of the value of the company. In many instances, when a company is purchased, a clearly defined intellectual property portfolio is necessary to determine the purchase price.

The insurance industry has increasingly been expanding to include policies and other insurance products to insure against the infringement of another's intellectual property, to insure the validity of an intellectual property asset, or to finance the enforcement of one's intellectual property rights. Many major carriers are offering some form of insurance related to intellectual property assets. It is accepted that there is a need to insure against losses related to certain types of activities related to intellectual property.

However, there is a gap in the insurance coverages for the protection of intellectual property, particularly with the most common types of transaction involving intellectual property, it's transfer, license, assignment or use as security. Given the increasing number of intellectual property asset transfers and the corresponding increase in the amount of money at risk in these transactions, it is increasingly important that those claiming to be the owner of an intellectual property asset are, in fact, the owners of the asset free of any claims on the asset that would prevent a subsequent licensee, assignee, mortgagee, purchaser or transferee from exploiting the rights attaching to those assets. And it is increasingly difficult to determine who, in fact, is the owner of an intellectual property asset, given the high volume and complexity of company mergers, acquisitions, bankruptcies, asset transfer agreements, licenses, credit line requests and other loans, and general assignment of rights. Failure to record assignment documents or informal transfers, the variability of contractual representations, and warranties and other obligations, all introduce significant uncertainty into a transfer of in many cases an asset having significant value. The person acquiring or taking an interest in an intellectual property asset does not have, as would be the case with a parcel of real property, a standard, formal assurance that title is properly vested in the entity purporting to own the property.

Therefore, there is a need for an intellectual property title insurance solution, so that transactions involving intellectual property (as with assurances of title involved in the transfer of real property) occur efficiently, accurately, and keep pace with the volume and pace of business transactions involving intellectual property assets.

### SUMMARY OF THE INVENTION

An intellectual property transaction assurance solution, and more specifically, a system and methodology for providing intellectual property asset title insurance is disclosed. The present invention provides an intellectual property title insurance solution that fills the aforementioned needs, and provides the title insurance policies, title commitments, and preliminary and final reports that assist those involved in intellectual property transactions to provide additional protection and insure against loss from a disputed claim of ownership for a particular intellectual property asset or group of assets.

In one aspect of the invention, an intellectual property asset title insurance policy is disclosed comprising intellectual property title insurance for insuring ownership of an intellectual property asset.

In another aspect of the invention, a method of providing title insurance for an intellectual property asset is disclosed. The method includes: determining title for the intellectual property asset; and issuing an intellectual property asset title insurance policy to insure the determined title of the intellectual property asset.

Various other features, objects and advantages of the present invention will be made apparent from the following detailed description and the drawings.

### BRIEF DESCRIPTION OF THE DRAWINGS

The drawings illustrate a preferred mode presently contemplated for carrying out the invention.

In the drawings:

FIG. 1 is a block diagram illustrating representative transactions involving intellectual property asset title insurance in accordance with one aspect of the present invention;

FIG. 2 is a block diagram illustrating representative internet transactions involving intellectual property asset title insurance in accordance with one aspect of the present invention;

FIG. 3 is a flow chart illustrating a representative process of issuing an intellectual property asset title insurance policy in accordance with one aspect of the present invention; and

FIG. 4 is a schematic FIG. 1 of a representative intellectual property asset title insurance policy in accordance with one aspect of the present invention.

### DETAILED DESCRIPTION OF THE PREFERRED EMBODIMENT

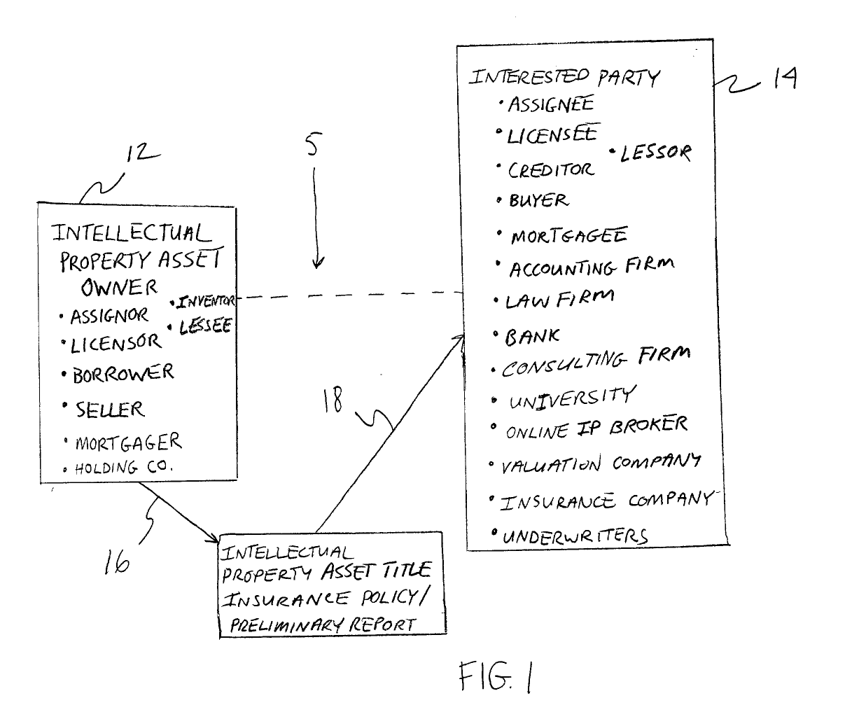

Referring now to FIG. 1, a block diagram illustrating representative transactions involving intellectual property asset title insurance that may be conducted in accordance with one aspect of the present invention is shown. A representative intellectual property based transaction (generally 5) having as a centerpiece an intellectual property asset title insurance policy 10 is shown. It is contemplated that the present invention may be used with any transaction, whether the transaction involves the transfer of intellectual property assets or not. Some transactions may include obtaining credit or a loan, leasing property, obtaining insurance or licensing, assigning or otherwise transferring or selling intellectual property. Policy 10 may be used to buy intellectual property assets, sell intellectual property assets, license intellectual property assets, transfer intellectual property assets, value intellectual property assets, borrow money, borrow against the intellectual property assets, or secure credit. Policy 10 may be used as part of a due diligence investigation of an intellectual property owner. The intellectual property asset title insurance policy 10 may be, for example, for intellectual property assets such as a patent, a patent application, a trademark, a trademark application, a copyright, a copyright application, an internet domain name, a trade name, a utility model, an industrial design, a laid-open application, a design patent, a utility patent, a plant patent, an internet website, trade dress, or any other intangible asset. One party to a transaction, in many cases, the owner 12 of the intellectual property asset, will generally be involved in the obtaining the intellectual property asset title insurance policy 10. Owner 12 may include an assignor, licensor, lessee, borrower, seller, mortgagor, holding company, beneficial owner or any other party that may be required to, or, in order to provide more certainty to a transaction 5, will voluntarily seek and obtain an intellectual property asset title insurance policy 10. While owner 12 may initiate the process, it is also possible that another interested party 14 will want the type of assurance that an intellectual property asset title insurance policy 10 and will encourage owner 12 to obtain such a policy or may order a policy 10 of their own. Party 14 may be any party that would be more likely to engage owner 12 in transaction 5 as a result of obtaining intellectual property asset title insurance policy 10. For example, interested parties 14 may be past, present or future assignees, licensees, creditors, buyers, mortgagees and may be representatives of accounting firms, law firms, banks, consulting firms, universities, online IP brokers, valuation companies, IP auction and marketing web sites (e.g., pl-x.com), insurance companies and underwriters. In the embodiment shown, owner 12 could obtain 16 intellectual property asset title insurance policy 10, after which intellectual property asset title insurance policy 10 can be shown to or used 18 by interested party 18 to complete transaction 5 or to otherwise obtain protection relating to the ownership of the intellectual property that is the subject of the transaction 5. The structure of the business relationship can be varied as is appropriate, and other intermediaries, representatives, agents and brokers may also fit into the overall transaction 5. In this manner, intellectual property asset title insurance policy 10 is part of an overall transaction assurance solution that facilitates transaction 5. The present invention has the attributes of a traditional title insurance policy for real property. A further discussion of these attributes may be found in D. Barlow Burke, Law of Title Insurance (2000), Aspen Publishing, the teachings and disclosures of which are incorporated herein by reference.

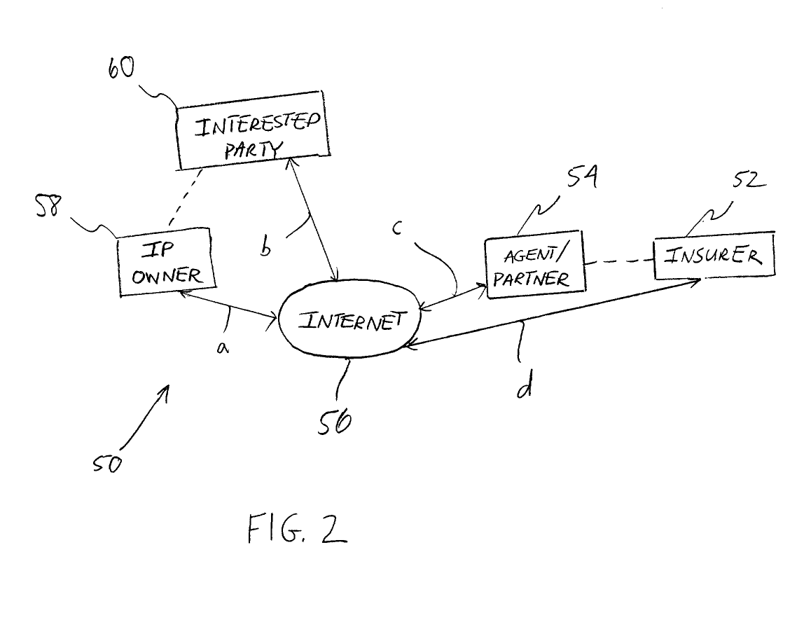

FIG. 2 is a block diagram illustrating representative Internet transactions involving intellectual property asset title insurance in accordance with one aspect of the present invention. Disclosed is an example of an arrangement of an intellectual property title insurance system 50 for obtaining a policy electronically. In this case, insurer 52 or issuer or broker of the IP title insurance policy may work directly or through various agent or partner entities 54 that work with insurer 52 to provide an intellectual property asset title insurance policy. For example, working through the Internet 56, insurance applications, investigation of the asset and issuance of the policy may all occur electronically through electronic documents, databases, email and the Internet 56. IP owners 58 and other interested parties 60 can communicate, provide relevant title insurance application information, pay for, and receive the IP title insurance policy via in-person, telephonic, fax or electronic means such as the internet 56 via communication channels a-d.

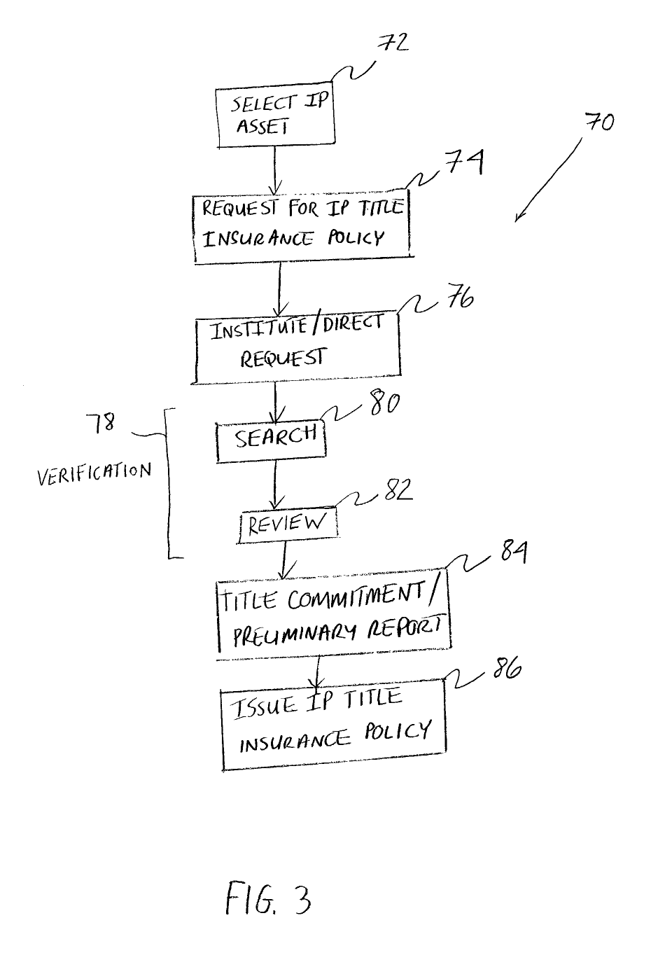

FIG. 3 is a flow chart illustrating a representative process of issuing an intellectual property asset title insurance policy in accordance with one aspect of the present invention. Shown in FIG. 3 is one embodiment of a process 70 of developing and issuing an intellectual property asset title insurance policy. This process is generally considered to be conducted by an insurer or related entity or partner, but individual pieces of data will be supplied by a database, the USPTO or the requester of the policy, asset holder or other interested party. First, it must be determined what particular intellectual property asset is desired to be insured for title. Therefore, the intellectual property asset must be selected 72. Next, a request is made 74 for an intellectual property title insurance policy, and that request is directed to another entity or instituted 76. Then the verification 78 phase begins. This is where any variety of quality added and value added services may be employed to gather the information necessary to make the determination as to whether to insure the risk. As part of this process, one or more searches 80 are conducted. The searching may include computerized public databases (such as USPTO, Copyright Office), private commercial searches, inquiries of previous and present owner, as well as other investigative and other information gathering procedures. The results of the IP title search are then reviewed 82 to clarify and remove inaccuracies and determine where there are serious title issues that will have to be excluded or made part of the policy as a rider, particularly where those matters cannot be resolved. The review process 82 may include obtaining additional information or certification from the asset holder, other interested party, or competitors or non-competitors' database, commercial service, or previous asset owner. The results of review 82 culminate in a title commitment or preliminary report 84, which is used to show and require that the liens, defects and objections to the title be paid or removed before a policy can be issued and the exceptions, if any, which will appear in the policy when issued. It is a binding obligation of the title company to issue the policy when the requirements of the Title Commitment have been complied with. After this time a transaction could close before issuance of the policy. After the issuance of the Title Commitment, and the criterion indicated therein is met, the intellectual property asset title insurance policy issues 86. Other methods of going from initiating the title insurance application process through issuance of an IP title insurance policy are contemplated to be within the scope of the present invention.

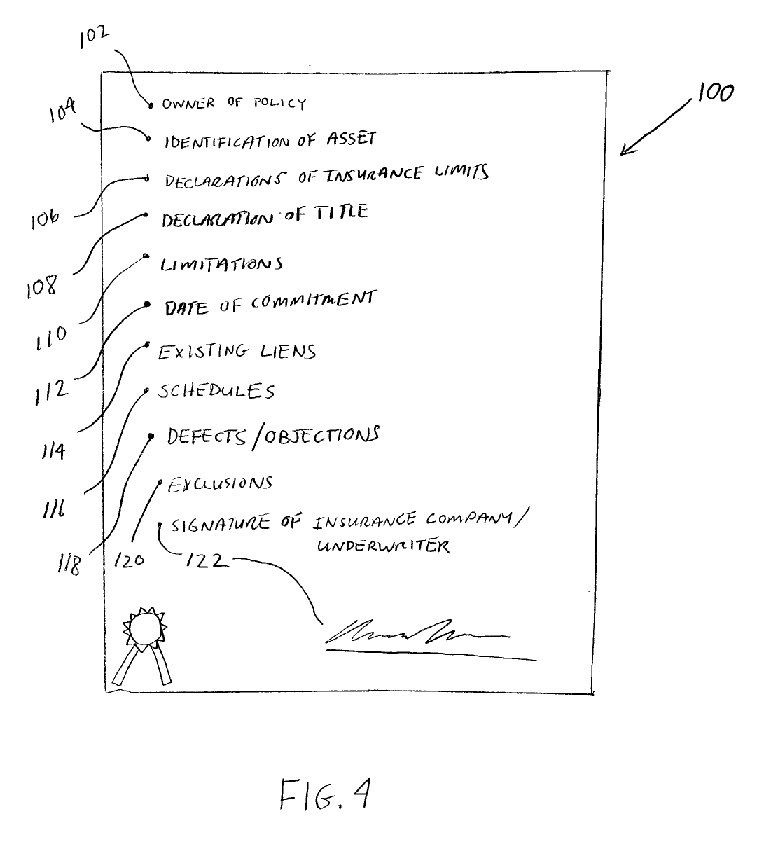

FIG. 4 is a schematic of a representative intellectual property asset title insurance policy in accordance with one aspect of the present invention. FIG. 4 shows a representative intellectual property title insurance policy certificate 100. Intellectual property title insurance would operate in a fashion similar to that of a title insurance policy for real property, namely that it would insure against losses caused by an entity not having full ownership of the intellectual property asset. For example, if a company was purchased, and the company owned a valuable patent, and the purchasing entity required, as a requirement for purchase, that a patent title insurance policy be obtained so as to insure that the patent is owned by the selling company, and that any problems with title to the patent can be learned at the time the policy is issued. Policy 100 can include aspects of traditional real estate title insurance as well as other aspects related specifically to intellectual property. Such exemplary areas include policy owner 102, identification of asset insured 104, declaration of insurance limits 106, declaration of title 108, limitations 110, date of commitment 1 12, existing liens 114, schedules 116, defects/objections 118, exclusions 120 and appropriate signatures 122 of the insurance company. The intellectual property title certificate may include riders, exclusions, endorsements, conditions and gap coverage. Many other types of sections are possible and the above title policy is a particular embodiment and the present invention is not limited to the format or content of the disclosed embodiment of an intellectual property asset title insurance policy.

Other methods and systems are contemplated as part of the present invention, and include a method of underwriting an intellectual property asset title insurance policy, wherein the underwriting includes verifying the title of the intellectual property asset through title insurance for the intellectual property asset and securing a second insurance policy based on the value of the intellectual property asset. Additionally, a method of confirming an intellectual property transfer transaction comprising: submitting an intellectual property title insurance application; and receiving confirmation of the title for the intellectual property via a title insurance certificate. A method of confirming an intellectual property transfer transaction is disclosed and comprises: providing an intellectual property asset; and obtaining intellectual property title insurance for the intellectual property asset.

More related methods include a system for insuring an the intellectual property asset comprising: a computer connected to a global communication system; an intellectual property asset; and an owner database for the intellectual property asset, the computer querying the owner database to determine the owner of the intellectual property asset; and an intellectual property asset title insurance certificate, wherein the certificate is issued stating the owner of the intellectual property asset based on the computer query.

A system for providing title insurance for an intellectual property asset, an internet website for providing title insurance services for intellectual property assets, an internet based system for information processing and policy issuance system related to intellectual property asset title, a system for automated title insurance for intellectual property assets, method of accessing and evaluating information for intellectual property asset title, a method of providing a line of credit against an intellectual property asset by securing the line of credit with an intellectual property asset insurance policy, a method for determining the cost of an intellectual property title insurance policy, a system for generating the intellectual property asset title insurance policy, a system for determining the cost of the intellectual property asset insurance policy, and a method of securing a transaction involving intellectual property comprising obtaining a title insurance policy for the intellectual property all are contemplated implementations and variations of the present invention. Other variations include wherein a licensor obtains a title insurance policy for the intellectual property asset, wherein a licensee obtains a title insurance policy for the intellectual property asset, wherein a bank obtains a title insurance policy for the intellectual property asset, wherein an assignor obtains a title insurance policy for the intellectual property asset, wherein an assignee obtains a title insurance policy for the intellectual property asset, wherein the title insurance policy for the intellectual property asset is used to verify title to the intellectual property asset on an internet asset auction, wherein the title insurance policy for the intellectual property asset is used with an intellectual property asset validity insurance policy, wherein the title insurance policy for the intellectual property asset is used with an intellectual property asset infringement insurance policy , wherein the title insurance policy for the intellectual property asset is used with an intellectual property asset enforcement insurance policy, wherein the title insurance policy utilizes chronology of assignment records of recorded documents that affect the ownership of an intellectual property asset, wherein the title insurance policy for the intellectual property asset is used with a registrar for an intellectual property asset, wherein the policy is secured by an intellectual property asset owner, wherein the policy is secured by an insurance company, wherein the policy is secured by an attorney, wherein the policy is secured by a bank, wherein the policy is secured by an accountant, wherein the policy is secured by a company, wherein the policy is secured by a consulting firm, wherein the policy is secured by an accounting firm, wherein the policy is secured by a taxing authority, wherein the policy is secured by a governmental entity, and wherein the policy is secured by an insurance company.

The present invention has been described in terms of the preferred embodiment, and it is recognized that equivalents, alternatives, and modifications, aside from those expressly stated, are possible and within the scope of the appending claims.

What is claimed is:

1. An intellectual property asset title insurance policy comprising intellectual property title insurance for insuring ownership of an intellectual property asset.

2. The intellectual property asset title insurance policy of claim 1 wherein the policy includes a coverage section including insuring, as of a date specific, title for a specific intellectual property asset.

3. The intellectual property asset title insurance policy of claim 1 wherein the policy includes at least one of a conditions section, a stipulation section and an exclusion from coverage section.

4. The intellectual property asset title insurance policy of claim 1 wherein the policy includes at least one schedule related at least one of a specific intellectual property asset, collateral, specific exceptions to coverage, existing financing statements, existing security interests, and existing liens of lien creditors.

5. The intellectual property asset title insurance policy of claim 1 wherein the intellectual property asset title insurance certificate is in electronic form.

6. The intellectual property asset title insurance policy of claim 1 wherein the intellectual property asset title insurance certificate is in paper form.

7. The intellectual property asset title insurance policy of claim 1 wherein the policy is obtained on an internet website for insuring title to intellectual property assets.

8. The method of claim 1 wherein the policy secures an intellectual property transfer transaction.

9. A method of insuring an intellectual property asset comprising: determining a present title to the intellectual property asset and issuing a policy as to the present title of the intellectual property asset.

10. A method of providing title insurance for an intellectual property asset comprising:
determining title for the intellectual property asset; or
issuing an intellectual property asset title insurance policy to insure the determined title of the intellectual property asset.

11. The method of claim 10 wherein the intellectual property asset is selected from the group consisting of a patent, a patent application, a trademark, a trademark application, a copyright, a copyright application, an internet domain name, a trade name, a utility model, an industrial design, a laid-open application, a design patent, a utility patent, a plant patent, an internet website, trade secret and trade dress.

12. The method of claim 10 wherein determining title of the intellectual property asset includes:
determining a chain of title for an intellectual property asset.

13. The method of claim 10 wherein the title certification includes issuing an intellectual property title insurance certificate.

14. The method of claim 10 further includes issuing the intellectual property asset title insurance policy over the internet.

15. A method of insuring ownership in an intellectual property asset comprising: insuring ownership of the intellectual property asset.

16. The method of claim 9 further includes retrieving available data on the title of the intellectual property asset and insuring the validity of the data.

17. The method of claim 9 wherein the policy secures an intellectual property transfer transaction.

18. An intellectual property asset title insurance policy comprising:
a certification of title for an intellectual property asset such that a present owner of the intellectual property asset is insured as an owner in fact of the intellectual property asset.

19. The intellectual property asset title insurance certificate of claim 18 wherein the certification of title insures the title of the intellectual property asset as of a specific date.

20. A method of insuring an intellectual property asset comprising: determining a present title to the intellectual property asset and issuing a policy as to the present title of the intellectual property asset.
